(19) United States
(12) Patent Application Publication
(10) Pub. No.: US 2020/0088925 A1
(43) Pub. Date: Mar. 19, 2020

(54) POLARIZED SCREEN PROTECTOR

(71) Applicant: Sasha Gillis, Brownsboro, AL (US)

(72) Inventor: Sasha Gillis, Brownsboro, AL (US)

(21) Appl. No.: 16/135,034

(22) Filed: Sep. 19, 2018

(51) Int. Cl. G02B 5/30; G02B 1/10

(52) U.S. Cl. CPC G02B 5/3025; G02B 1/10

(57) ABSTRACT

A polarized screen protector assembly for reducing glare on a display when viewed outdoors includes an electronic device that has a display thereon for displaying electronic images. A film is positionable over the display and the film is comprised of a translucent material such that the display is visible through the film. The film is comprised of a polarized material such that the film passes light therethrough at a selected angle. In this way the film reduces glare when the display is viewed in sunlight. An adhesive layer is coupled to the film and the adhesive layer adhesively engages the display when the film is positioned on the display to retain the film on the display.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to polarized devices and more particularly pertains to a new polarized device for reducing glare on a display when viewed outdoors.

### BRIEF SUMMARY OF THE INVENTION

An embodiment of the disclosure meets the needs presented above by generally comprising an electronic device that has a display thereon for displaying electronic images. A film is positionable over the display and the film is comprised of a translucent material such that the display is visible through the film. The film is comprised of a polarized material such that the film passes light therethrough at a selected angle. In this way the film reduces glare when the display is viewed in sunlight. An adhesive layer is coupled to the film and the adhesive layer adhesively engages the display when the film is positioned on the display to retain the film on the display.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a film of polarized screen protector assembly according to an embodiment of the disclosure.

FIG. 2 is a right side view of film, adhesive layer and protective sheet of an embodiment of the disclosure.

FIG. 3 is a cross sectional view taken along line 3-3 of FIG. 1 of an embodiment of the disclosure.

FIG. 4 is an exploded perspective view of an embodiment of the disclosure.

FIG. 5 is a perspective view of an alternative embodiment of the disclosure.

### DETAILED DESCRIPTION OF THE INVENTION

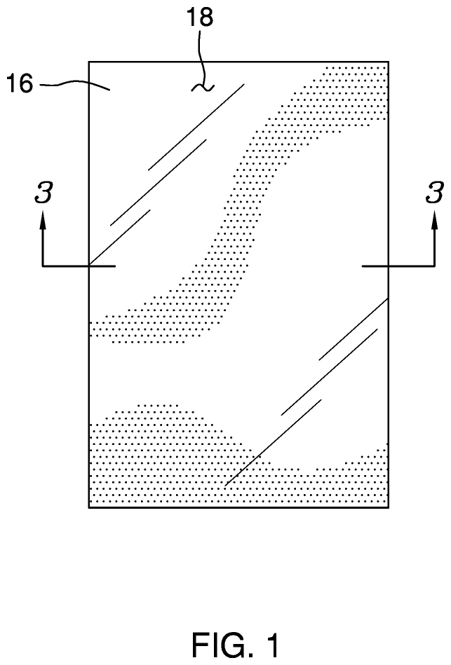

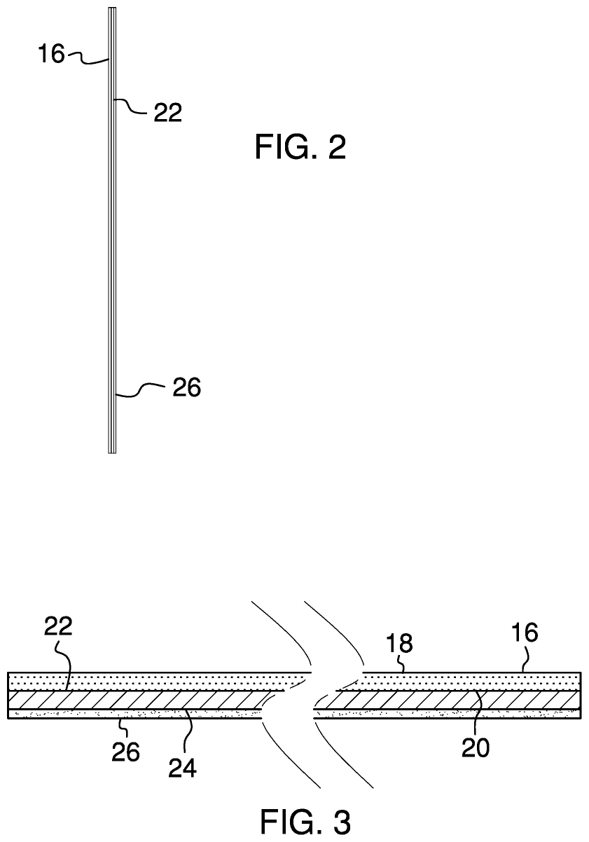

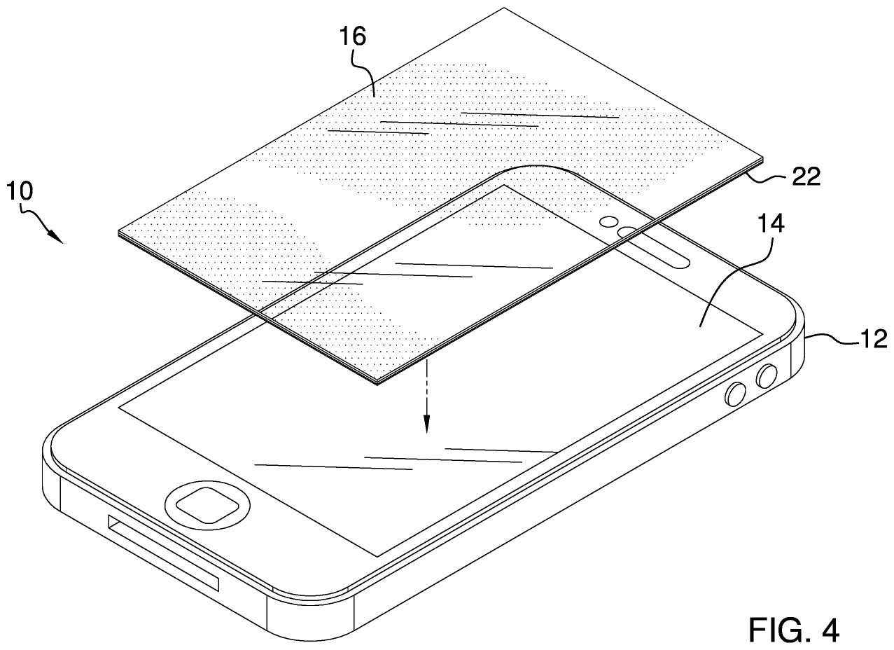

With reference now to the drawings, and in particular to FIGS. 1 through 5 thereof, a new polarized device embodying the principles and concepts of an embodiment of the disclosure and generally designated by the reference numeral 10 will be described.

As best illustrated in FIGS. 1 through 5, the polarized screen protector assembly 10 generally comprises an electronic device 12 that has a display 14 thereon for displaying electronic images. The electronic device 12 may be a smartphone, a tablet computer or any other handheld electronic device 12 with a display 14. The display 14 may be an LED, an LCD or any other electronic display commonly found on handheld electronic devices. A film 16 is positionable over the display 14 and the film 16 is comprised of a translucent material such that the display 14 is visible through the film 16. Moreover, the film 16 is comprised of a polarized material such that the film 16 passes light therethrough at a selected angle. In this way the film 16 reduces glare when the display 14 is viewed in sunlight. The film 16 has a top surface 18 and a bottom surface 20.

An adhesive layer 22 is coupled to the film 16 and the adhesive layer 22 adhesively engages the display 14 when the film 16 is positioned on the display 14 to retain the film 16 on the display 14. The adhesive layer 22 is positioned on and completely covers the bottom surface 20 of the film 16. Additionally, the adhesive layer 22 has an exposed surface 24 with respect to the film 16 and the exposed surface 24 adhesively engages the display 14. The adhesive layer 22 may comprise a non-residual adhesive that can be used repeatedly to adhere to the display 14.

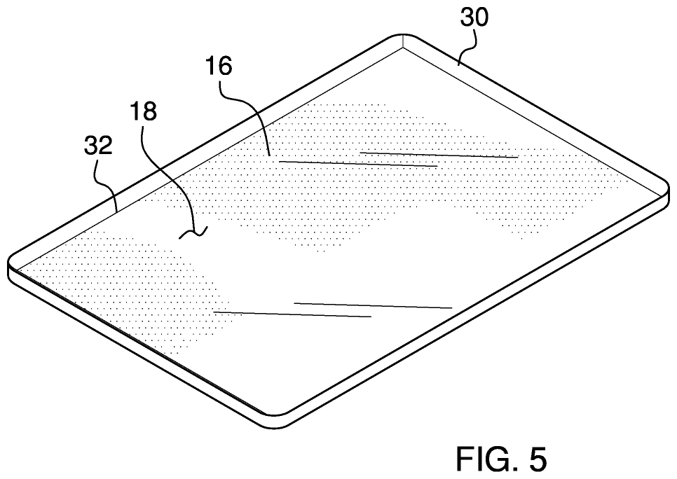

A protective sheet 26 is removably positioned on the adhesive layer 22 for protecting the adhesive layer 22. The protective sheet 26 is removed from the adhesive layer 22 prior to applying the film 16 to the display 14. The protective sheet 26 is positioned on and completely covers the exposed surface 24 of the adhesive layer 22. Moreover, the protective sheet 26 is selectively peeled from the exposed surface 24 for applying the protective sheet 26 on the display 14 The protective sheet 26 may comprise laminated paper or the like that resists adhering to the adhesive layer 22. In an alternative embodiment 28 as shown in FIG. 5, a barrier 30 is coupled to and extends upwardly from the top surface 18 of the film 16. The barrier 30 is aligned with and is coextensive with a perimeter edge 32 of the film 16 to inhibit the display 14 from being visible to an observer.

In use, the protective sheet 26 is removed from the adhesive layer 22 and the film 16 is applied to the display 14 such that the adhesive layer 22 engages the display 14. Thus, the film 16 is removably retained on the display 14. The film 16 reduces glare when the display 14 is being viewed in sunlight. In this way the film 16 enhances visibility of videos or images being displayed on the display 14 when the display 14 is viewed outdoors. As shown in FIG. 5, the barrier 30 facilitates a degree of privacy when the display 14 is being viewed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A polarized screen protector assembly being configured to reduce glare on a display screen in direct sunlight, said assembly comprising:
an electronic device having a display thereon for displaying electronic images;
a film being positionable over said display, said film being comprised of a translucent material such that said display is visible through said film, said film being comprised of a polarized material such that said film passes light therethrough at a selected angle wherein said film is configured to reduce glare when said display is viewed in sunlight; and
an adhesive layer being coupled to said film, said adhesive layer adhesively engaging said display when said film is positioned on said display to retain said film on said display.

2. The assembly according to claim 1, wherein:
said film has a top surface and a bottom surface; and
said adhesive layer is positioned on and completely covers said bottom surface of said film, said adhesive layer having an exposed surface with respect to said film, said exposed surface adhesively engaging said display.

3. The assembly according to claim 2, further comprising a protective sheet being removably positioned on said adhesive layer for protecting said adhesive layer, said protective sheet being removed from said adhesive layer prior to applying said film to said display said protective sheet being positioned on and completely covering an exposed surface of said adhesive layer, said protective sheet being selectively peeled from said exposed surface.

4. The assembly according to claim 2, further comprising a barrier being coupled to and extending upwardly from said top surface of said film, said barrier being aligned with and being coextensive with a perimeter edge of said film wherein said barrier is configured to inhibit said display from being visible to an observer.

5. A polarized screen protector assembly being configured to reduce glare on a display screen in direct sunlight, said assembly comprising:
an electronic device having a display thereon for displaying electronic images;
a film being positionable over said display, said film being comprised of a translucent material such that said display is visible through said film, said film being comprised of a polarized material such that said film passes light therethrough at a selected angle wherein said film is configured to reduce glare when said display is viewed in sunlight, said film having a top surface and a bottom surface;
an adhesive layer being coupled to said film, said adhesive layer adhesively engaging said display when said film is positioned on said display to retain said film on said display, said adhesive layer being positioned on and completely covering said bottom surface of said film, said adhesive layer having an exposed surface with respect to said film, said exposed surface adhesively engaging said display; and
a protective sheet being removably positioned on said adhesive layer for protecting said adhesive layer, said protective sheet being removed from said adhesive layer prior to applying said film to said display, said protective sheet being positioned on and completely covering said exposed surface of said adhesive layer, said protective sheet being selectively peeled from said exposed surface.

6. The assembly according to claim 5, further comprising a barrier being coupled to and extending upwardly from said top surface of said film, said barrier being aligned with and being coextensive with a perimeter edge of said film wherein said barrier is configured to inhibit said display from being visible to an observer.
